(19) United States
(12) Patent Application Publication
(10) Pub. No.: US 2018/0039066 A1
(43) Pub. Date: Feb. 8, 2018

(54) ADJUSTABLE FOCUS LOUPE EYEGLASSES

(71) Applicant: Doo Hyun KANG, Seoul (KR)

(72) Inventor: Doo Hyun KANG, Seoul (KR)

(21) Appl. No.: 15/551,588

(22) PCT Filed: Feb. 16, 2016
(86) PCT No.: PCT/KR2016/001565

§ 371 Date: Aug. 16, 2017

(30) Foreign Application Priority Data
Feb. 16, 2015 (KR) 10-2015-0023049

(51) Int. Cl. G02B 25/00; G02C 5/04; G02B 23/18; G02C 5/12; G02C 7/08; G02B 25/04; G02C 11/00

(52) U.S. Cl. CPC G02B 25/002; G02B 25/04; G02C 5/04; G02C 11/10; G02C 5/124; G02C 7/088; G02B 23/18; G02B 7/002

(57) ABSTRACT

The present invention relates to adjustable focus loupe eyeglasses comprising: side frames on both sides thereof; a front frame with a glasses frame structure; and a loupe mounting unit for mounting a loupe, the loupe mounting unit being installed so as to be slidable right and left along the front frame, wherein the front frame is configured such that a portion between both ends thereof in the longitudinal direction of the plane surface forms a circular arc shape around a preset front focal point, and has a guide hole which is formed vertically through the upper portion thereof and has a length along the circular arc shape, and wherein the loupe mounting unit comprises: a locking part which is fixed to or is slidable along the guide hole; and a rim which is arranged on the bottom of the locking part and on which a loupe is mounted, wherein the loupe mounted on the rim is configured such that a focal spot magnified by the loupe mounting unit being guided along the guide hole faces toward the center of the circular arc of the guide hole.

### TECHNICAL FIELD

The present invention relates to focus-adjustable loupe glasses, and more particularly, to focus-adjustable loupe glasses that facilitate adjustment of an interval between pupils of a glasses wearer and adjustment of focuses of the loupe glasses while worn.

### BACKGROUND ART

Generally, loupes are used to magnify jewelry, precision parts, and the like or to magnify surgical procedure sites in the case of medical applications.

In particular, loupes for medical use take the form of glasses in accordance with need for an operator to use both hands.

Loupes for medical use have recently been variously developed and are disclosed in, for example, Korean Utility Model Publication No. 20-2008-0003938 (hereinafter, referred to as ‘Prior Art 1’), Japanese Patent Laid-Open Publication No. 2014-041218 (hereinafter, referred to as ‘Prior Art 2’), and the like.

In this regard, Prior Art 1 discloses loupes in which ocular lenses are positioned proximate to eyes of a user, the loupes including object lenses and body tubes, thus being small in size and lightweight.

Prior Art 2 discloses loupes provided with ocular lenses spaced apart from eyes of a user by a distance, the loupes including larger sizes of object lenses and body tubes than those of the loupes disclosed in Prior Art 1.

In Prior Art 1, a glasses frame to be worn on the human body is provided with a long hole in a front surface of an upper portion thereof to allow loupes installed at lenses of the frame to slide therealong or to be fixed to upper portions of the lenses.

However, in loupe glasses of Prior Art 1, the loupes are fixed to lenses and thus a sliding position has to be determined in a state in which a user wears the loupe glasses, and, when the sliding position is determined, the sliding position is fixed using a coupling bolt after taking off the loupe glasses while stably maintaining the sliding position, resulting in user inconvenience.

In addition, according to Prior Art 1, an interval between pupils of a loupe wearer may be adjusted, but there is a problem in that individual loupe wearers are unable to adjust the loupes to desired different focal distances.

Meanwhile, Prior Art 2 discloses adjustment instruments installed at a glasses frame to adjust an interval of loupes and to match the focus of the loupes with the predetermined focal position.

However, the structure of Prior Art 2 includes a combination of many parts such as a plurality of arms, a fixing part for fixing the arms, and the like that constitute the adjustment instruments and thus is complicated. In addition, the combination of these configurations is installed at the front of the glasses frame, and thus the concentration a loupe wearing sensation is reduced due to the self-weight of the loupes and inconveniences such as forward inclination, and the like occur.

In addition, according to Prior Art 2, once a focal position of the loupes is determined, the focal position cannot be adjusted to another focal position during use, and thus, when a user wants to change a magnification focus position, as in Prior Art 1, a process, in which the magnification focus position is adjusted after taking off the frame and then the frame is put on again, has to be repeated, resulting in user inconvenience.

### DISCLOSURE

### Technical Problem

Therefore, the present invention has been made in view of the above problems, and technical goals of the present invention are as follows.

It is one object of the present invention to provide focus-adjustable loupe glasses that simultaneously enable adjustment of an interval between opposite pupils of a user in a state in which the user wears the loupe glasses and simultaneous adjustment of the focus of each loupe.

It is another object of the present invention to provide focus-adjustable loupe glasses that enable adjustment of focal distances of opposite loupes according to selection of a user in a state in which the user wears the loupe glasses.

It is yet another object of the present invention to provide focus-adjustable loupe glasses that have a simplified structure and are lightweight, and, accordingly, have enhanced wearability and problems such as forward inclination and the like when the loupe glasses are put on may be prevented.

It is still another object of the present invention to provide focus-adjustable loupe glasses in which a cover (lens) capable of protecting eyes of a loupe glasses wearer from foreign substances may be selectively installed.

### Technical Solution

In accordance with one aspect of the present invention, provided is a focus-adjustable loupe glasses comprising side frames on opposite sides thereof, a front frame having a glasses frame structure, and loupe mounting units allowing loupes to be mounted to be slidable leftward or rightward along the front frame, wherein the front frame is configured such that a portion between opposite longitudinal ends thereof on a plane has an arc shape about a previously set front focal position, and is provided, at an upper side portion thereof, with guide holes vertically penetrating the front frame and having a length along the arc shape, and each loupe mounting unit comprises: a fastening part slid along or fixed to the guide hole; and a rim arranged below the fastening part and allowing a loupe to be installed, wherein focuses of the loupes installed at the rims, magnified by guiding the loupe mounting unit by the guide holes, direct towards centers of arcs of the guide holes.

A fastening part of the loupe mounting unit comprises any one selected from: (a) a configuration comprising: a support having a lower end connected to the rim and having a pillar shape; a guide protruding from a central portion of an upper end of the support by less than a thickness of the front frame provided with the guide holes, inserted into the guide hole from a lower side thereof so as to prevent rotation thereof, and provided with a nut at a center of an upper end thereof; and a bolt supported by a periphery of an upper portion of the guide hole and fastened corresponding to the nut, (b) a configuration, corresponding to a configuration in which the guide hole is provided, at a periphery of an upper portion thereof, with a guide groove forming a step with respect to the guide hole and extending in at least a width direction, comprising: a slider having a rectangular shape with a length, having a lower portion inserted into the guide hole so as to prevent rotation thereof and protruding downside of the front frame, having an upper surface that is the same as or protrudes farther than an upper surface of the front frame, and provided, at an upper center portion thereof, with a through-hole vertically passing therethrough; a support having a lower end connected to the rim, having a pillar shape, and provided with a rotation prevention groove into which a nut at a center of an upper end thereof and the slider at a periphery of the nut are inserted; a bolt supported by a periphery of an upper portion of the slider and fastened corresponding to the nut via the through-hole of the slider, (c) a configuration, corresponding to a configuration in which the guide hole is provided, at a periphery of a lower portion thereof, with a guide groove forming a step with respect to the guide hole and extending in at least a width direction, comprising: a support having a lower end connected to the rim and having a pillar shape; a guide inserted into the guide groove at a central portion of an upper end of the support so as to prevent rotation thereof and provided with a nut at a center of the upper end thereof; and a bolt supported by a periphery of an upper portion of the guide hole and fastened corresponding to the nut, and (d) a configuration, corresponding to a configuration in which the guide hole is provided, at peripheries of upper and lower portions thereof, with upper and lower guide grooves, respectively, forming a step with respect to the guide hole and extending in at least a width direction, comprising: a support provided with a nut at a central portion of an upper end thereof; a slider having a through-hole with a rectangular shape at a center thereof and inserted into the lower and upper guide grooves; and a bolt to be fastened with the nut via the through-hole from the upper.

The focus-adjustable loupe glasses further include each of a plurality of covers corresponding to a front surface of the front frame, having a thin plate shape, having a hook portion with an inwardly bent shape at an upper portion thereof, and provided with an insertion groove cut corresponding to a side surface of the loupe, wherein the hook part at an upper portion of the cover is positioned in the form of covering head side portions of the bolt of the loupe mounting unit and supported thereby, and the insertion groove at a lower portion of the cover is positioned in the form of covering opposite side portions and an upper portion of the loupe previously installed and supported thereby.

The focus-adjustable loupe glasses include: an auxiliary frame having a rod shape, having a longitudinal middle portion in the form of a forwardly convex and curved shape, and having longitudinal opposite ends fixed to the corresponding longitudinal opposite ends of the front frame or the corresponding side frames; and an interval adjustment part between the auxiliary frame and the front frame to adjust an interval therebetween, wherein adjustment of the interval between the auxiliary frame and the front frame by the auxiliary frame and the interval adjustment part is performed by forming variations of focal position of the loupes by degrees of unbending or more bending the front frame using the auxiliary frame as a support base.

The front frame is provided with a nut hole at a longitudinal middle portion thereof, and the interval adjustment part is a bolt to be fastened with the nut hole of the front frame using the auxiliary frame as a support base.

### Advantageous Effects

According to configurations of the present invention, a longitudinal middle portion of a front frame as well as guide holes have a convex arc shape, focuses of loupes guided by the guide holes are automatically aligned corresponding to centers of the arcs of the respective guide holes, and a bending degree of the front frame is adjusted via an auxiliary frame and an interval adjustment part and, accordingly, adjustment of a focal position is easy.

In addition, according to the configurations of the present invention, loupes can be stably positioned in front of the eyes of a user and, accordingly, small loupes can be installed, and the front frame, which is a support base, enables focus alignment of the loupes, thus enabling simplified structure and light weight, and, accordingly, wearability of a loupe glasses wearer can be enhanced and problems such as forward inclination of the loupes can be addressed by reducing the weight thereof.

In addition, hook-type covers are configured and thus are selectively installed and conveniently detached.

### DESCRIPTION OF DRAWINGS

FIG. 1 is an exploded perspective view for explaining configurations of focus-adjustable loupe glasses according to an embodiment of the present invention and a coupling relationship between these configurations.

FIG. 2 is a perspective view illustrating an assembly state of the configurations of the focus-adjustable loupe glasses of FIG. 1.

FIGS. 3A to 3D are schematic partial enlarged cross-sectional views for explaining configurations of fastening parts according to various embodiments and a coupling relationship between the configurations according to each embodiment, in which the views are taken along a line III-III of FIG. 1.

FIG. 4 is a plan view for explaining a relation between adjustment of an interval adjustment part on a front frame and an auxiliary frame and a change in focal position.

FIG. 5 is a schematic cross-sectional view illustrating a state in which a loupe mounting unit is installed on a front frame.

### BEST MODE

The present invention provides focus-adjustable loupe glasses including side frames on opposite sides thereof, a front frame having a glasses frame structure, and loupe mounting units allowing loupes to be mounted to be slidable leftward or rightward along the front frame, wherein the front frame is configured such that a portion between opposite longitudinal ends thereof on t plane has an arc shape about a previously set front focal position, and is provided, at an upper side portion thereof, with guide holes vertically penetrating the front frame and having a length along the arc shape, and each loupe mounting unit includes: a fastening part slid along or fixed to the guide hole; and a rim arranged below the fastening part and allowing a loupe to be installed, wherein focuses of the loupes installed at the rims, magnified by guiding the loupe mounting unit by the guide holes, are directed towards centers of arcs of the guide holes.

### [Mode]

Hereinafter, exemplary embodiments of the present invention will be described in detail, and a detailed description of configurations the same or within the same range as those of prior arts will be omitted.

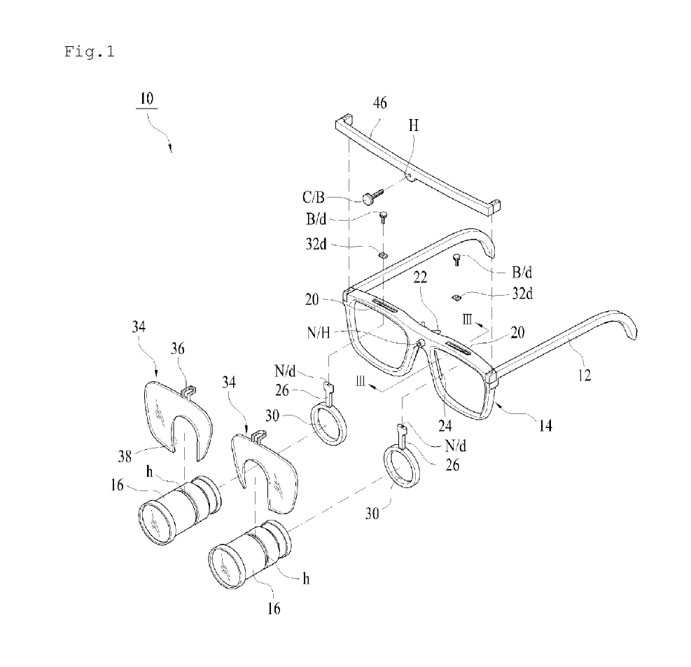

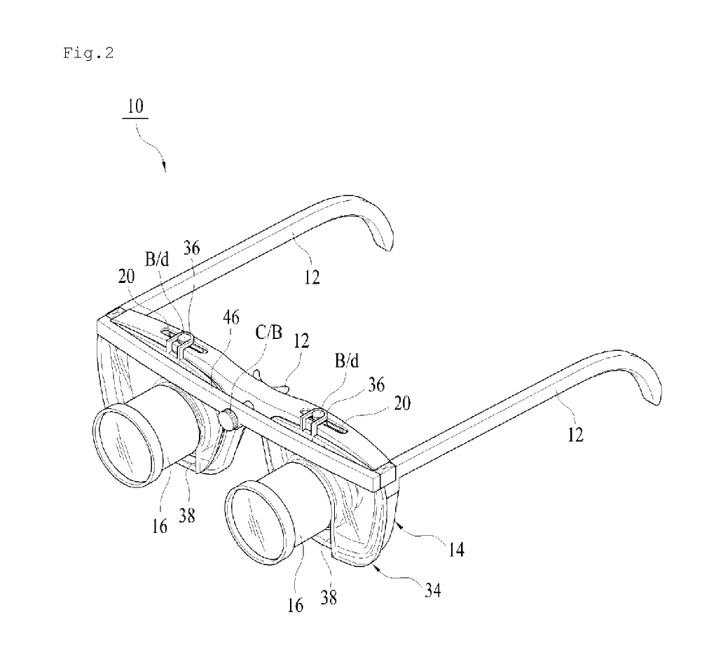

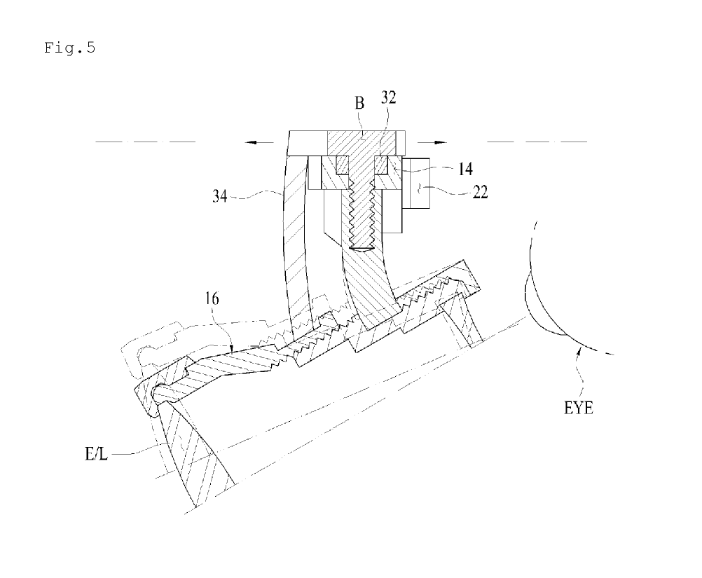

As illustrated in FIGS. 1 to 5, focus-adjustable loupe glasses 10 according to an embodiment of the present invention include side frames 12 on opposite sides thereof, a front frame 14 having a glasses frame structure, and loupe mounting units 18 allowing loupes 16 to be mounted and configured such that the loupes 16 are slidable leftward or rightward along the front frame 14.

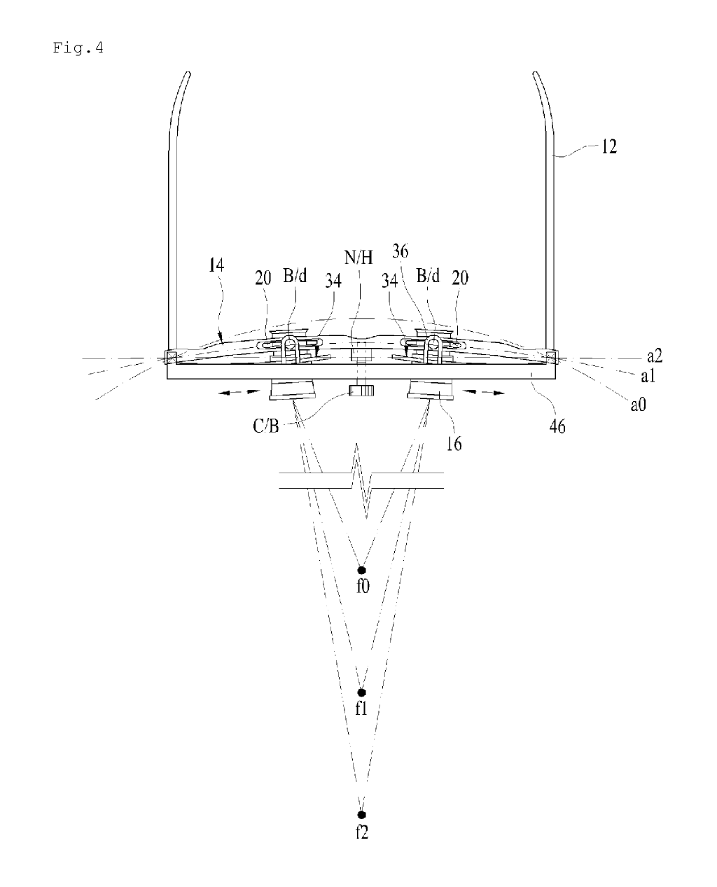

In the front frame 14 of the present invention, as illustrated in FIG. 4, a portion between opposite longitudinal ends thereof on the plane has an arc a0 shape about the predetermined front focal (f0) position.

In addition, the front frame 14 is provided, at an upper side portion thereof, with guide holes 20 vertically penetrating the front frame 14 and having a length along the arc a0 shape of the front frame 14.

In addition, the front frame 14 is provided with a nut N to be fastened with a bolt B in the front thereof at a longitudinal center portion at a front surface thereof.

In addition, the front frame 14 is provided, at a rear surface thereof, with a support member 22 performing a support function by close contact with the middle of the forehead or the forehead of a loupe glasses wearer, a support 24 mounted on a nasal bridge or in the vicinity thereof of a loupe glasses wearer to support a lower portion of the front frame 14, and the like.

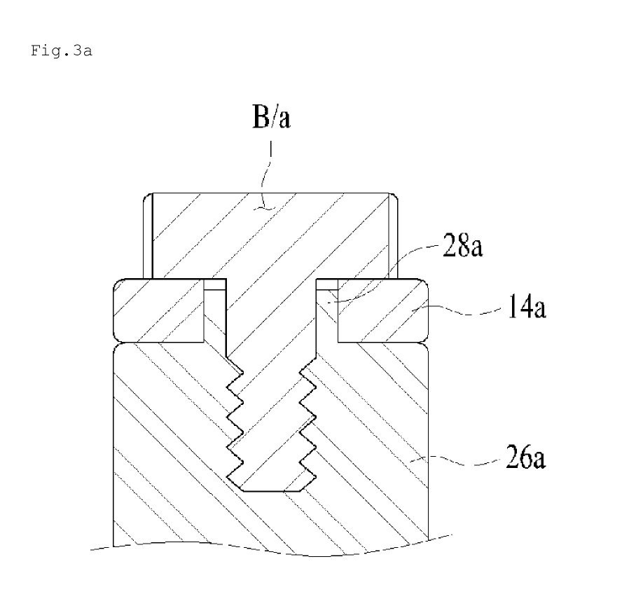

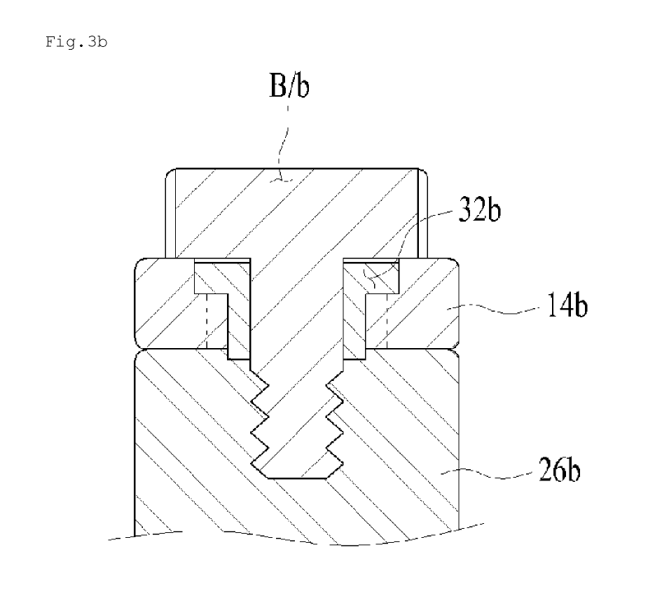

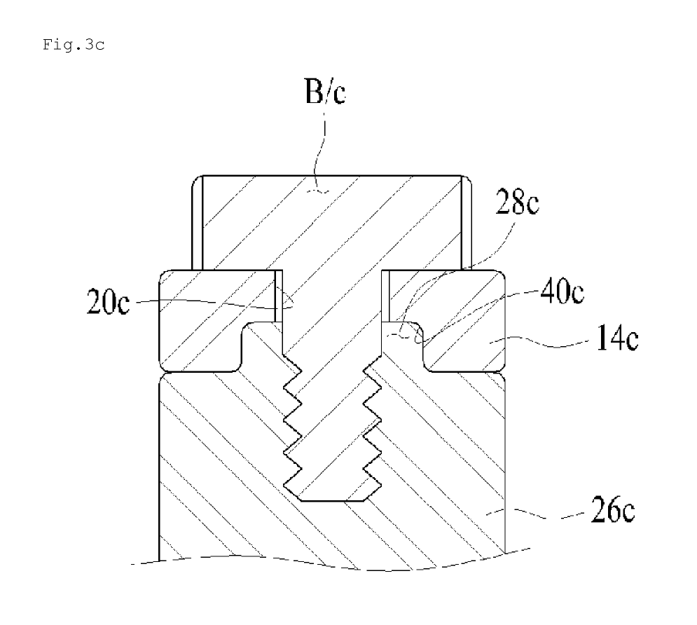

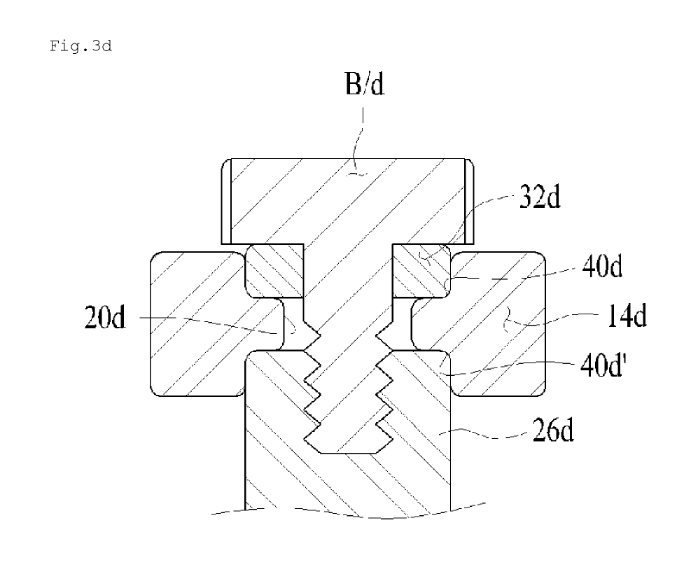

In the foregoing description of the front frame 14, the guide holes 20 are configurations for installation of the loupe mounting units 18, and, as illustrated in FIGS. 3A to 3D, may have various shapes. Each of various embodiments of the guide holes 20 will be described in further detail with regards to installation of the loupe mounting units 18, which will be described below.

First, the guide holes 20 of FIG. 3A form an arc along a longitudinal direction of the front frame 14 at an upper side portion of the front frame 14, positioned above eyes of a loupe glasses wearer, and vertically penetrate the front frame 14.

Loupe mounting units 18a, as an embodiment corresponding to the guide holes 20, include supports 26a having a pillar shape.

An upper surface of an upper end of each support 26a closely contacts the periphery of a lower surface of the guide hole 20a at the corresponding position to be supported by a front frame 14a, and a portion of the upper surface of the support 26a, corresponding to the guide hole 20a, is provided with a guide 28a protruding therefrom, forming a step with respect to the upper surface, and being inserted into the guide hole 20a.

In addition, the guide 28a is provided, at a center of an upper surface thereof, with a nut N/a having a vertical depth.

In this regard, the support 26a may be configured such that an upper side portion thereof is long in a length direction (a longitudinal direction) and is relatively narrow in a width direction (a thickness direction) with respect to the longitudinal direction, so that front and rear surface portions of the support 26a do not protrude outside the width direction of the front frame 14a.

In addition, the guide 28a is long in a length direction of the guide hole 20a along the shape of the upper side portion of the support 26a and has a width corresponding to the guide hole 20a so that rotation thereof is prevented and the guide 28a is slidably inserted via the guide hole 20a.

Accordingly, the upper portion of the support 26a is horizontally slidable by being guided by the lower surface of the front frame 14a and an inner surface of the guide hole 20a.

In addition, a lower end of the support 26 is connected to a rim 30 having a shape covering a rear side portion of the loupe 16.

In addition, a loupe mounting unit 18a includes a bolt B/a to be fastened with the nut N/a of the support 26a at an upper portion of the front frame 14a.

Meanwhile, in each of the other embodiments except for the loupe mounting units 18a of one embodiment, other configurations including connection of the rims 30 to the lower ends are within the same ranges, except for shapes of fastening parts corresponding to the guide holes formed in the front frame 14.

Prior to description of the structure of the fastening part according to each of the other embodiments, guide holes 20b formed in a front frame 14b have a cross-sectional shape such that, as illustrated in FIG. 3B, a guide groove 40b forming a step with respect to each guide hole 20b and extending in at least a width direction is formed at the periphery of an upper portion of the guide hole 20b.

A fastening part of another embodiment corresponding thereto includes a slider 32b having a block shape with a length, having side portions inserted into the guide groove 40b, having a lower portion inserted into the guide hole 20b so as to prevent rotation thereof and protruding downward of the front frame 14b, having an upper surface that is the same as or protrudes farther than the upper surface of the front frame 14b, and provided, at an upper center portion thereof, with a through-hole 42b vertically passing therethrough.

In addition, a support 26b corresponding to a lower portion of the periphery of the guide hole 20b and the slider 32b is provided, at an upper surface thereof, with a rotation prevention groove 44b, into which the slider 32b protruding downward of the front frame 14b is correspondingly inserted, and a nut N/b with the predetermined depth is disposed at the center of the rotation prevention groove 44b corresponding to the through-hole 42.

In addition, the front frame 14b may be provided, at an upper portion thereof, with a bolt B/b supported by the periphery of an upper portion of the slider 32b and fastened corresponding to the nut N/b via the through-hole 42 of the slider 32b.

Meanwhile, as illustrated in FIG. 3C, fastening parts of loupe mounting units 18c according to another embodiment include: corresponding to a configuration in which a guide groove 40c forming a step with respect to a guide hole 20c and extending in at least a width direction is formed at the periphery of a lower portion of the guide hole 20c, a support 26c provided, at a central portion of an upper end thereof, with a slider 32c inserted into the guide groove 40c so as to prevent rotation thereof and provided with a nut N/C with the predetermined depth at the center of an upper end thereof; and a bolt B/c supported by the periphery of an upper portion of the guide hole 20c and fastened corresponding to the nut N/c.

In addition, as illustrated in FIG. 3D, fastening parts of loupe mounting units 18d according to another embodiment include: corresponding to a configuration in which a guide hole 20d is provided, at the peripheries of upper and lower portions thereof, with guide grooves 40d and 40d′, respectively, forming a step with respect to the guide hole 20d and extending in at least a width direction, a support 26d provided with a nut N/d at a central portion of an upper end thereof; a slider 32d having a through-hole h′ with a rectangular shape at a center thereof and inserted into the upper and lower guide grooves 40d and 40d′; and a bolt B/d to be fastened with the nut N/d via the through-hole h′ from an upper side thereof.

From the foregoing description of the loupe mounting units 18 of each embodiment, it can be confirmed that the loupe mounting units 18 have a structure for guiding via sliding and arrangement thereof so that focuses of the loupes 16 installed at the rims 30 are directed towards the centers of the arcs of the front frame 14 regardless of movement positions via sliding along the guide holes 20.

In the above-described loupe mounting units 18, the supports 26 may be bent towards focus directions of the loupes 16 at the predetermined angle with respect to a plane state of an upper portion of the front frame 14 when viewed by a loupe glasses wearer.

In addition, the loupe 16 is provided in plural such that indicating angles of the loupes 16 according to the bent form range from 20° to 40° with respect to a horizontal plane of the upper portion of the front frame 14, thus enabling a loupe glasses wearer to select desired angles of the supports 26.

Such a structure is configured because viewing positions of a loupe glasses wearer (an operator) are varied while performing a surgical procedure.

With regards to this, for example, viewing angles of dentists with respect to the horizontal plane of the upper portion of the front frame 14 generally range from about 20° to about 30°, and surgeons generally use a support such as a table or the like to prevent arms thereof from shaking and viewing angles of surgeons with respect to the horizontal plane of the upper portion of the front frame 14 range from about 30° to about 40°, which corresponds to a case in which a surgeon lowers his or her head while standing upright and looks downward more than in the case of dentists.

Meanwhile, the front frame 14 at which the loupes 16 are installed is provided with covers 34 to block impurities discharged from lateral directions of the loupes 16, i.e., sites viewed by the loupes 16, from being spattered around eyes of a loupe glasses wearer.

The covers 34 may take the form of a thin film made of a transparent or opaque material, corresponding to an edge of a front surface of the front frame 14.

In addition, the covers 34 are installed such that, as illustrated in FIGS. 1, 2, 4, and 5, each cover 34 has a hook portion 36 with an inwardly bent shape at an upper portion thereof, which is a previously determined position, and inner sides of the hook parts 36 are hung in the form of covering head parts of the bolts B positioned at upper portions of the opposite sides of the front frame 14 and the hook parts 36 support upper portions of the covers 34.

In addition, each cover 34 is provided with an insertion groove 38 cut corresponding to a side surface of the loupe 16, corresponding to a region from a lower portion to a middle portion to an upper side portion of the cover 34.

The insertion groove 38 covers a region from side portions of opposite sides to an upper side portion of the loupe 16, and is movable forward or backward to adjust the focus of an ocular lens O/L.

Thus, the covers 34 are supported by the bolts B installed at the upper portions of the front frame 14 and also cover the side portions of the loupes 16.

The covers 34 are configured in a separate form because the covers 34 are installed by being hooked on the bolts B installed at the upper portions of the front frame 14, thus facilitating detachment thereof according to selection of a loupe glasses wearer.

Meanwhile, the front frame 14 includes, at a front portion thereof, an auxiliary frame 46 having a rod shape, having a longitudinal middle portion in the form of a forwardly convex and curved shape, and having longitudinal opposite ends fixed to the corresponding longitudinal opposite ends of the front frame 14 or the corresponding side frames 12.

In addition, the focus-adjustable loupe glasses further include an interval adjustment part 48 between the auxiliary frame 46 and the front frame 14 to adjust an interval therebetween.

The interval adjustment part 48 is configured such that a through-hole H is formed in a middle portion of the auxiliary frame 46, a nut hole N/H is formed in a middle portion of the front frame 14, corresponding to the through-hole H, and the interval adjustment part includes a control bolt C/B to be fastened with the nut hole N/H via the through-hole H by using the auxiliary frame 46 as a support base.

In this regard, flexibility (bending degree) of the auxiliary frame 46 may be equal to or less than flexibility of at least the front frame 14.

That is, rigidity of the auxiliary frame 46 may be the same as or higher than that of the front frame 14.

As such, adjustment of the interval between the auxiliary frame 46 and the front frame 14 by the auxiliary frame 46 and the interval adjustment part 48 may be performed by, as illustrated in FIG. 4, forming variations of focal position f0, f1, and f2 of the loupes 16 by degrees a0, a1, and a2 of unbending or more bending the front frame 14 using the auxiliary frame 46 as a support base.

1. Focus-adjustable loupe glasses comprising side frames on opposite sides thereof, a front frame having a glasses frame structure, and loupe mounting units allowing loupes to be mounted to be slidable leftward or rightward along the front frame,
wherein the front frame is configured such that a portion between opposite longitudinal ends thereof on a plane has an arc shape about a previously set front focal position, and is provided, at an upper side portion thereof, with guide holes vertically penetrating the front frame and having a length along the arc shape, and
each loupe mounting unit comprises: a fastening part slid along or fixed to the guide hole; and a rim arranged below the fastening part and allowing a loupe to be installed,
wherein focuses of the loupes installed at a rims, magnified by guiding the loupe mounting unit by the guide holes, direct towards centers of arcs of the guide holes.

2. The focus-adjustable loupe glasses according to claim 1, wherein a fastening part of the loupe mounting unit comprises any one selected from:
(a) a configuration comprising: a support having a lower end connected to the rim and having a pillar shape; a guide protruding from a central portion of an upper end of the support by less than a thickness of the front frame provided with the guide holes, inserted into the guide hole from a lower side thereof so as to prevent rotation thereof, and provided with a nut at a center of an upper end thereof; and a bolt supported by a periphery of an upper portion of the guide hole and fastened corresponding to the nut,
(b) a configuration, corresponding to a configuration in which the guide hole is provided, at a periphery of an upper portion thereof, with a guide groove forming a step with respect to the guide hole and extending in at least a width direction, comprising: a slider having a rectangular shape with a length, having a lower portion inserted into the guide hole so as to prevent rotation thereof and protruding downside of the front frame, having an upper surface that is the same as or protrudes farther than an upper surface of the front frame, and provided, at an upper center portion thereof, with a through-hole vertically passing therethrough; a support having a lower end connected to the rim, having a pillar shape, and provided with a rotation prevention groove into which a nut at a center of an upper end thereof and the slider at a periphery of the nut are inserted; a bolt supported by a periphery of an upper portion of the slider and fastened corresponding to the nut via the through-hole of the slider,
(c) a configuration, corresponding to a configuration in which the guide hole is provided, at a periphery of a lower portion thereof, with a guide groove forming a step with respect to the guide hole and extending in at least a width direction, comprising: a support having a lower end connected to the rim and having a pillar shape; a guide inserted into the guide groove at a central portion of an upper end of the support so as to prevent rotation thereof and provided with a nut at a center of the upper end thereof; and a bolt supported by a periphery of an upper portion of the guide hole and fastened corresponding to the nut, and
(d) a configuration, corresponding to a configuration in which the guide groove is provided, at peripheries of upper and lower portions thereof, with upper and lower guide hole, respectively forming a step with respect to the guide hole and extending in at least a width direction, comprising: a nut provided at a central portion of an upper end of the support and inserted into lower guide grooves; a slider having a through-hole with a rectangular shape at a center thereof and inserted into the upper guide grooves; and a bolt to be fastened with the nut via the through-hole from an upper of the slider.

3. The focus-adjustable loupe glasses according to claim 2, further comprising each of a plurality of covers corresponding to a front surface of the front frame, having a thin plate shape, having a hook portion with an inwardly bent shape at an upper portion thereof, and provided with an insertion groove cut corresponding to a side surface of the loupe,
wherein the hook part at an upper portion of the cover is positioned in the form of covering head side portions of the bolt of the loupe mounting unit and supported thereby, and the insertion groove at a lower portion of the cover is positioned in the form of covering opposite side portions and an upper portion of the loupe previously installed and supported thereby.

4. The focus-adjustable loupe glasses according to claim 1, further comprising: an auxiliary frame having a rod shape, having a longitudinal middle portion in the form of a forwardly convex and curved shape, and having longitudinal opposite ends fixed to the corresponding longitudinal opposite ends of the front frame or the corresponding side frames; and an interval adjustment part between the auxiliary frame and the front frame to adjust an interval therebetween,
wherein adjustment of the interval between the auxiliary frame and the front frame by the auxiliary frame and the interval adjustment part is performed by forming variations of focal position of the loupes by degrees of unbending or more bending the front frame using the auxiliary frame as a support base.

5. The focus-adjustable loupe glasses according to claim 4, wherein the front frame is provided with a nut hole at a longitudinal middle portion thereof, and the interval adjustment part is a bolt to be fastened with the nut hole of the front frame using the auxiliary frame as a support base.
